(19) United States
(12) Patent Application Publication
(10) Pub. No.: US 2010/0080298 A1
(43) Pub. Date: Apr. 1, 2010

(54) Refined Weighting Function and Momentum-Directed Genetic search pattern algorithm

(76) Inventors: Hsueh-Ming Hang, Hsin-Chu Hsien (TW); Tzu-Yi Chao, Hsin-Chu City (TW); Chang-Che Tsai, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 12/490,337

(22) Filed: Jun. 24, 2009

Related U.S. Application Data
(60) Provisional application No. 61/101,155, filed on Sep. 30, 2008.

(51) Int. Cl. H04N 7/32

(52) U.S. Cl. 375/240.16; 375/E07.125

(57) ABSTRACT

A weighting function (WF) is previously provided to model the number of search points of a pattern search. However, WF fails to properly describe the behavior of the genetic pattern search algorithms due to some over-simplifications in their models. Therefore, a refined weighting function (RWF) is provided to more accurately describe both genetic and non-genetic pattern searches. Moreover, based on the understanding to RWF, two momentum-directed genetic search algorithms are further provided. These new algorithms check the possible mutations according to their likelihood to the preceding successful mutations and further accelerate the previous genetic pattern searches.

### CROSS REFERENCE TO RELATED APPLICATIONS

This application claims the benefit of U.S. Provisional Application No. 61/101,155, filed on Sep. 30, 2008 and entitled “On Modeling Genetic Pattern Searches for Block Motion Estimation” the contents of which are incorporated herein.

### BACKGROUND OF THE INVENTION

1. Field of the Invention

The present invention relates to processing of digital image data, and more particularly, to compression techniques such as Block Motion Estimation (BME) and related features which are useful in coding video signal sequences.

2. Description of the Prior Art

Motion Estimation (ME) is a tool used frequently in the art of image processing to find a motion vector that best describes an object in one domain and its corresponding object in another domain. Most modern video coding circuits, such as employed in H.26x and MPEG compatible systems, typically adopt a branch of ME, namely so called BME to help eliminate the inter-frame dependencies. For contemporary examples of this type of technique, please see the following, all of which are incorporated by reference herein: [1] Kim et al. “Fast motion estimation apparatus and method using block matching algorithm”, US patent, Pub. No.: US 2006/0280248 A1, Dec. 14, 2006. [2] Thomas Wiegand, et al. “Overview of the H.264/AVC video coding standard”, IEEE Trans. Circuits Systm. Video Technolog, vol. 13, no. 7, July 2003.

Please refer to FIG. 1. FIG. 1 is a diagram illustrating a conventional method for BME process. As shown in FIG. 1, a motion vector can be found that best describes a current block in one current image frame and its corresponding reference block within the search area in the other frame(s). The location differences of the reference block within the prior frame and co-located block within the current frame are described as the motion vectors. Typically a 16×16, 16×8, 8×16, 8×8, 8×4, 4×8, or 4×4 block is used for the BME procedure. BME is conventionally used in a number of block-matching video compression systems, such as H.261/263/264 as well as MPEG-1/2/4. In a BME approach, reference frames typically consist of the temporal previous coded frame. In some instances, it may consist of both the temporal previous coded frames and the temporal successive coded frames.

For example:
Presentation Sequence: I₁, P₂, B₃, P₄, B₅, P₆, B₇, B₈, P₉, B₁₀, P₁₁, B₁₂, P₁₃, I₁₄ . . .
Coding Sequence: I₁, P₂, P₄, B₃, P₆, B₅, P₉, B₇, B₈, P₁₁, B₁₀, P₁₃, B₁₂, I₁₄.

In deciding which reference block most resembles a current selected block, one usually calculates the corresponding block-matching discrepancy. Any of a number of different techniques may be employed to measure such discrepancy.

One of the most commonly used block-matching discrepancy measures is the Sum of Absolute Differences (SAD). The SAD of a current block having a size N×M compared to a reference block with a displacement of (vₓ, v_{y}) relative to the current block in the reference frame is defined as:

$$SAD ( {v}_{x} , {v}_{y} ) = {\sum }_{i = 1}^{N} {\sum }_{j = 1}^{M} \vert \begin{matrix}{I}_{n} ( x + i , y + j ) - \\ {I}_{n - 1} ( x + i + {V}_{x} , y + j + {V}_{y} )\end{matrix} \vert ; \qquad ( 1 )$$

Where Iₙ is the current frame and Iₙ₋₁ is the reference frame, (x, y) is the location of the current block.

As noted above, in a block-matching algorithm, a current frame of video image data is divided into a plurality of individual current blocks of a particular size. BME finds a corresponding reference block in the search window of the reference frames for each of the blocks. The displacements of the reference blocks from the previous frame to the current frame are determined as respective corresponding motion vectors.

One type of BME algorithms employs what is referred to as a full search (FS) algorithm. In the FS algorithm, each reference block within a current frame is compared with all of a plurality of blocks within a predetermined search region of a reference frame. The FS algorithm is a useful technique in that it provides block matching with high precision and a simple data flow. In addition, the structure of a control circuit used for executing the FS algorithm is relatively simple. However, it can be seen quite easily that the FS algorithm requires a considerable amount of computation, especially when the search region becomes large.

In order to reduce the time/computation requirements associated with FS algorithms, various fast pattern search methods have been suggested. Using a search pattern instead of each block in an entire frame is advantageous as it reduces the number of points to be searched. These search patterns are devised therefore by taking advantage of the characteristics of a distribution of motion vectors, thereby enhancing the speed of the motion estimation process.

While it is known to use different kinds of search patterns for a BME process, the process for determining what kind of search patterns to be used and when to use them is still very much an unpredictable art. Therefore there is a very pronounced and long-felt need for both improved BME search patterns as well as tools for evaluating the performance of potential search patterns, and adaptively identifying which of such patterns may be most appropriate for particular image sequences.

### SUMMARY OF THE INVENTION

The present invention provides an adaptive method of performing block motion estimation. The method comprises (a) calculating a motion vector variance for a first frame according to a first search pattern, (b) determining a relationship between the motion vector variance and a predetermined threshold for the first frame, and (c) selecting a first or a second search pattern algorithms for identifying one or more search blocks in a second frame according to the determined relationship between the motion vector variance and the predetermined threshold for the first frame, wherein the predetermined threshold is determined by refined weighting functions of the first and the second search pattern algorithms, the refined weighting functions of the first and the second pattern algorithms are numbers of average search points for the first and the second pattern algorithms searching in the first frame, and block motion estimation is performed adaptively for the second frame.

The present invention further provides a momentum-directed genetic pattern search method of performing block motion estimation for a frame. The method comprises (a) selecting a child point proximate to a parent point according to likelihood to previous successful mutations, (b) comparing block matching cost of the parent point and block matching cost of the child point, and (c) setting either the parent point or the child point as a surviving parent point for a successful mutation according to the compared result of the step (b).

The present invention further provides a momentum-directed genetic rhombus pattern search method of performing block motion estimation for a frame. The method comprises (a) selecting a child point from a perimeter portion of a rhombus centered about a parent point according to likelihood to previous successful mutations, (b) comparing block matching cost of the parent point and block matching cost of the child point, and (c) setting either the parent point or the child point as a surviving parent point for a successful mutation according to the compared result of the step (b).

The present invention further provides a momentum-directed genetic hexagonal pattern search method of performing block motion estimation for a frame. The method comprises (a) selecting a child point from a perimeter portion of a hexagon centered about a parent point according to likelihood of the parent point according to previous successful mutations, (b) comparing block matching cost of the parent point and block matching cost of the child point, and (c) setting either the parent point or the child point as a surviving parent point for a successful mutation according to the compared result of the step (b).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the idea of BME process.

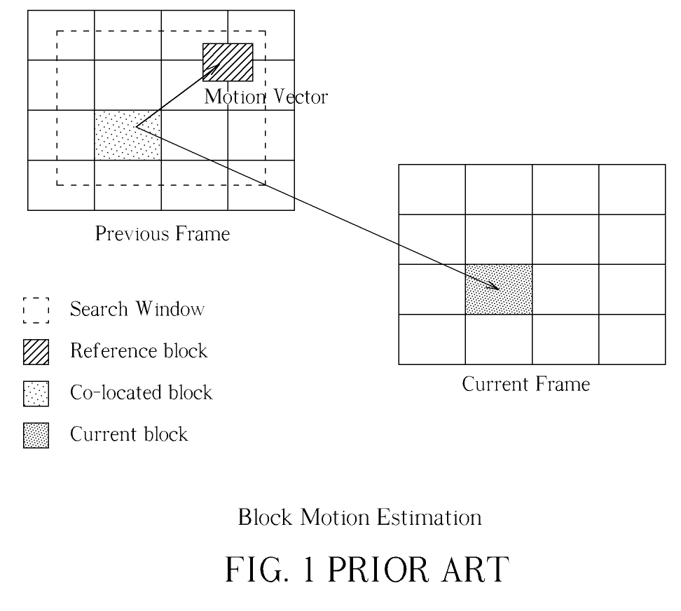

FIG. 2 is a diagram illustrating all possible search order for a parent point with four possible mutation points and only one of them is feasible.

FIG. 3 is a diagram illustrating all possible search order for a parent point with four possible mutation points and only two of them is feasible.

FIG. 4 is a flowchart of the GRPS.

FIG. 5 is a diagram illustrating the search patterns of GRPS.

FIG. 6 is a diagram illustrating the contour plot of the feasible number of mutation points for each point in the search area.

FIG. 7 is a diagram illustrating two cases of starting search points and two cases of intermediate search points.

FIG. 8 is a diagram illustrating the construction of RWF of the present invention.

FIG. 9 is a diagram illustrating the contour plot of RWF of GRPS of the present invention.

FIG. 10 is a flowchart of GPHS.

FIG. 11 is a diagram illustrating the search pattern of GPHS.

FIG. 12 is a diagram illustrating the feasible number of mutations of GPHS.

FIG. 13 is a diagram illustrating the contour plot of RWF of GPHS of the present invention.

FIG. 14 is a diagram illustrating the contour plot of RWF of MD-GRPS of the present invention.

FIG. 15 is a flowchart illustrating the MD-GRPS algorithm of the present invention.

FIG. 16 is a diagram illustrating the search order of possible mutation points of MD-GRPS algorithm of the present invention.

FIG. 17 is a diagram illustrating the contour plot of RWF of MD-GPHS algorithm of the present invention.

FIG. 18 is a flowchart of MD-GPHS of the present invention.

FIG. 19 is a diagram illustrating the search order of possible mutation points in MD-GPHS algorithm of the present invention.

### DETAILED DESCRIPTION

The present invention provides method for evaluating the performance of search pattern and further provides momentum-directed genetic search pattern algorithms. Therefore users can utilize the most suitable search pattern by the evaluation result. Furthermore, users can utilize the momentum-directed genetic search pattern of the present invention so that the computational requirement for searching the motion vector of the inter-frame can be reduced.

Basic Assumption: the present invention assumes the matching error (distortion) surface is uni-modal, and furthermore, a Strong Quadrant Monotonic (SQM) function.

The present invention provides a mathematical model (as expressed by the equation (2)˜(4)) to evaluate the computational requirement of a search pattern utilized in a video sequence:

$$\begin{matrix}ASP = {C}_{1} \times {\sum }_{x , y ∈ A} {S}_{SP 1} ( x , y ) \times {WF}_{SP 2} ( x , y ) + {C}_{2} ; & ( 2 ) \\ {S}_{SP 1} ( x , y ) = \frac{\frac{1}{{\vert x \vert}^{5 / 3} + {ζ}_{x}} \frac{1}{{\vert y \vert}^{5 / 3} + {ζ}_{y}}}{{\sum }_{( {x}^{′} , {y}^{′} ) ∈ A} \frac{1}{{\vert {x}^{′} \vert}^{5 / 3} + {ζ}_{x}} \frac{1}{{\vert {y}^{′} \vert}^{5 / 3} + {ζ}_{y}}} ; & ( 3 ) \\ PMV = median ( {MV}^{L} , {MV}^{U} , {MV}^{UR} ) ; & ( 4 )\end{matrix}$$

where ASP represents the average number of search points produced by a PBME, SP₁ represents a first search pattern, SP₂ represents a second search pattern, S_{SP1} represents the Motion Vector (MV) probability distribution function of the search pattern SP₁, WF_{SP2} (Weight Function) represents the minimal search points for a motion vector located at the coordinates (x,y) by utilizing the search pattern SP₂, C₁ and C₂ are two constant parameters, and MV^{L}, MV^{U}, and MV^{UR} are the MVs of the left, up, and up-right block neighbors to current block.

In the present invention, SP₁ can be realized with the full search, and SP₂ can be realized with any search pattern.

This model consists of two components: a statistical probability distribution function S_{SP1}(x,y) of MVs (expressed by the equation (3)), and the minimal search points for a MV located at the coordinates (x,y), WF_{SP2}(x,y). In the equation (2), (x,y) are the relative coordinates of which the origin is “PMV” expressed by the equation (4). The parameters C₁ and C₂ are obtained experimentally by training methods. Note that C₁ is always positive because ASP (equation (2)) and the sum of products of S_{SP1}(x,y) and WF_{SP2}(x,y) are always positively correlated.

The equation (3) is derived based on the experimental data. In the equation (3), (x,y) and (x′,y′) are relative coordinates with respect to (w.r.t.) “PMV”, and “A” represents the search area. The parameters (ζₓ, ζ_{y}) are obtained b numerical methods such that the variances of S_{SP1}(x,y) match those of the MVs acquired by the first search pattern on a specific sequence.

There are two methods to obtain the values of parameters C₁ and C₂. In the first method, the parameters C₁ and C₂ are obtained from a set of training sequences with one specific search algorithm. In the second method, the parameters C₁ and C₂ are obtained by applying a set of search algorithms (training algorithms) to a specific sequence. Then the “ASP” value of a new algorithm can be predicted by using the mathematical model of the present invention. The first and the second methods are designed for different scenarios. The first method is used to predict the ASP of a new sequence (for a given specific search algorithm), while the second method is used to predict the ASP of a new search algorithm (for a given specific sequence).

Therefore, if one search pattern algorithm has lower ASP than any other search pattern algorithm does, it meant that this search pattern algorithm is more suitable than any other search pattern algorithm for this video sequence.

However, if the search pattern SP₂ is a genetic search pattern, since the nature of the genetic search pattern is randomly selecting one child point neighboring the parent point, thus the probability of each possible child point neighboring the parent point has to be considered. In this way, the weighting function WF is not suitable to describe the number of the search points of a genetic search pattern. Therefore, the present invention provides a Refined Weighting Function (RWF) to describe the number of a genetic search pattern with higher accuracy. Consequently, the WF in the equation (2) is replaced with the RWF as the following equation expresses:

$$ASP = {C}_{1} \times {\sum }_{x , y ∈ A} {S}_{SP 1} ( x , y ) \times {RWF}_{SP 2} ( x , y ) + {C}_{2} \qquad ( 5 )$$

where the search pattern SP₂ can be a genetic search pattern. Therefore, the equation (5) is utilized in the present invention as the refined model to characterize the behavior of a genetic pattern search.

In one embodiment of the present invention, the genetic search pattern can be Genetic Rhombus Pattern Search (GRPS) or Genetic Point oriented Hexagonal Search (GPHS). The present invention provides a method for determining which of the GRPS and the GPHS is more suitable for a video sequence. According to the equation (5), the ASPs of the GRPS and GPHS respectively are:

$$\begin{matrix}{ASP}_{GRPS} = {C}_{1} \times {\sum }_{x , y ∈ A} {S}_{SP 1} ( x , y ) \times {RWF}_{GRPS} ( x , y ) + {C}_{2} ; \\ and & ( 6 ) \\ {ASP}_{GRHS} = {C}_{1} \times {\sum }_{x , y ∈ A} {S}_{SP 1} ( x , y ) \times {RWF}_{GPHS} ( x , y ) + {C}_{2} . & ( 7 )\end{matrix}$$

Comparatively, when we use the first method to predict the ASP of a new sequence, the prediction differences between adopting WF and RWF in the model are similar. It is because statistical regressions effectively compensate the difference in parameter C₁ and C₂.

According to the equations (6) and (7), if the ASP_{GRPS} is higher than the ASP_{GPHS}, it means the GPHS has better performance than the GRPS for the video sequence, and vice versa. Therefore, an average search point difference D_{ASP} can be derived according to the equations (6) and (7):

$${D}_{ASP} = {C}_{1} \times {\sum }_{x , y ∈ A} {S}_{SP 1} ( x , y ) \times ( \begin{matrix}{RWF}_{GRPS} ( x , y ) - \\ {RWF}_{GPHS} ( x , y )\end{matrix} ) ; \qquad ( 8 )$$

and a performance difference index I_{ASP} between the GRPS and the GPHS can be derived from the equation (8) by dividing the equation (8) with the constant parameter C₁:

$${I}_{ASP} = {\sum }_{x , y ∈ A} {S}_{SP 1} ( x , y ) \times ( {RWF}_{GRPS} ( x , y ) - {RWF}_{GPHS} ( x , y ) ) . \qquad ( 9 )$$

When the performance difference index I_{ASP}>0, the GPHS is significantly superior to GRPS, and when the performance difference index I_{ASP}<0, the GRPS is significantly superior to GPHS. Thus, users can utilize the performance difference index I_{ASP} to determine which genetic search pattern algorithm to be used.

Consequently, for simplicity, the equation (9) can be approximated by a linear function which is expressed as follows:

P×VARₓ+Q×VAR_{y}−TH=0 (10);

where P and Q represent constants, TH represents a predetermined threshold, VARₓ represents the horizontal motion vector variance, and VAR_{y} represents the vertical motion vector variance. The value of the predetermined threshold can be estimated by the RWF of the GRPS and the RWF of the GPHS. Therefore, it is quite obvious that the refined model adopting RWF shows better accuracy than the original model adopting WF.

The details of the refined weighting function (RWF) of the present invention will be explained in the following description.

It is assmed that the matching error surface is a strong Quadrant Monotonic function. Let O=(xₒ, yₒ) be the optimum search point, and A=(x_{A}, y_{A}) and X=(xₓ, yₓ) are any two points in the search range, and (|A−X|<R_{nbd}, (Say, R_{nbd}=3)). If |A−O|>|X−O| implies D(X)<D(A), then this D(X) is a strong quadrant monotonic function.

The RWF, or RWF(x,y), is defined to be the average number of search points needed by a search algorithm on a SQM matching error surface when the best matching point is located at (0,0) and the starting point is (x,y).

For a genetic search algorithm, when a parent point is with N possible mutation points and m out of the N points have smaller matching error, the expected number of search points to move from the parent point to one feasible mutation point is Eₘ^{N}, as shown in the equation (11):

$$\begin{matrix}\begin{matrix}{E}_{m}^{N} = \frac{m}{N} + \frac{m}{N} {\sum }_{j = 1}^{N - m} ( ( j + 1 ) \times {\prod }_{i = 1}^{j} ( \frac{( N - m ) - ( i - 1 )}{N - i} ) ) \\ = \frac{N + 1}{m + 1} ;\end{matrix} & ( 11 ) \\ Where N > m . & \end{matrix}$$

In the present invention, it is assumed that the probability for selecting any of the mutation points is equal. On a SQM matching error surface, the number of the feasible mutation points, m, is decided by the relative locations between the current parent point and the global optimal point. N is decided by the search point and the parent point type (a starting parent point or an intermediate parent point).

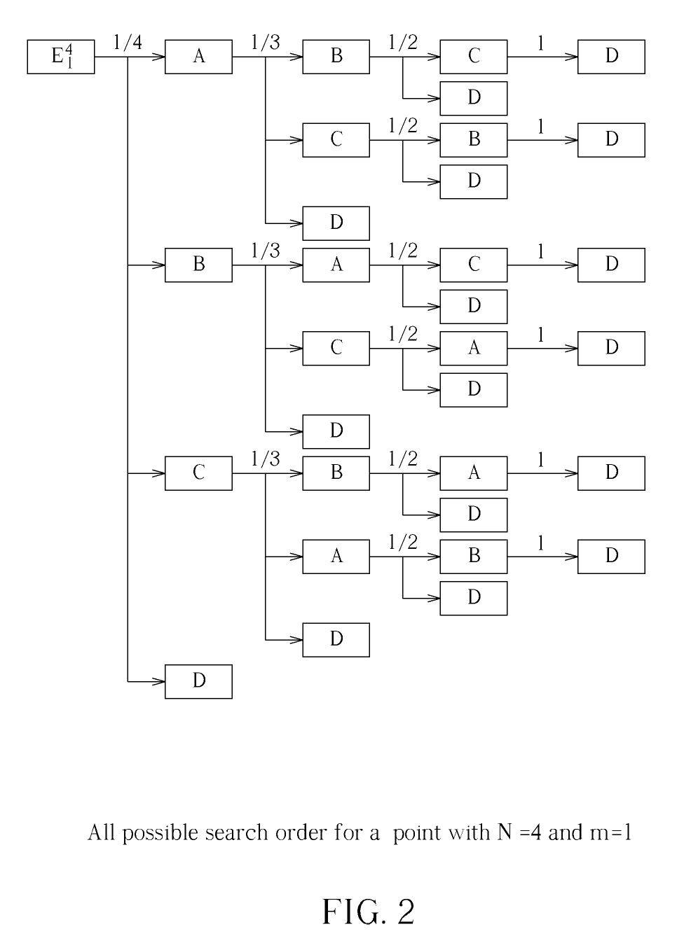

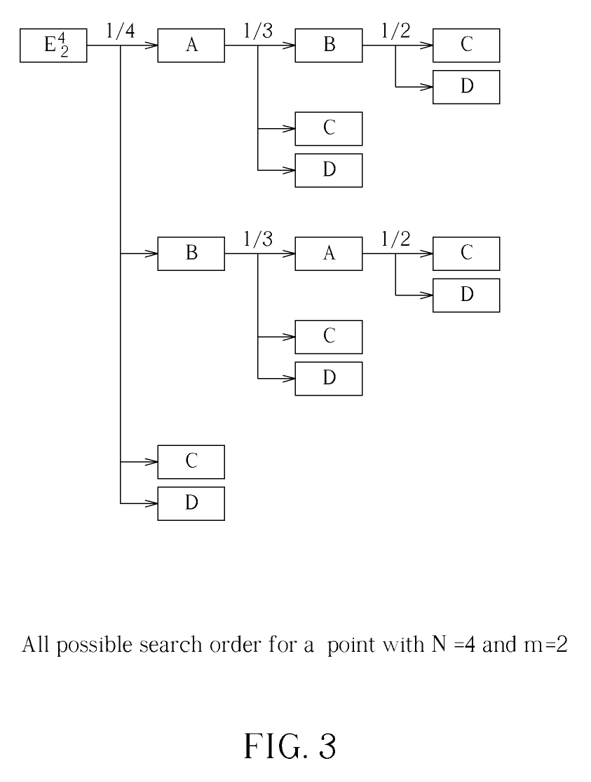

Please refer to FIG. 2 and FIG. 3. FIG. 2 is a diagram illustrating all possible search order for a parent point with four possible mutation points, denoted by A, B, C, and D, respectively, and only one of them, denoted by D, is with smaller matching distortion. FIG. 3 is a diagram illustrating all possible search order for a parent point with four possible mutation points, denoted by A, B, C, and D, respectively, and two of them, denoted by C and D, are with smaller matching distortion. The equations (12) and (13) show the calculations of their expected value to move from the parent point to a feasible mutation point of FIG. 2 and FIG. 3, respectively:

$$\begin{matrix}{E}_{1}^{4} = [ \begin{matrix}[ \begin{matrix}[ \begin{matrix}\frac{1}{4} \times \frac{1}{3} \times \frac{1}{2} \times 1 \times 4 + \\ \frac{1}{4} \times \frac{1}{3} \times \frac{1}{2} \times 3\end{matrix} ] \times 2 + \\ \frac{1}{4} \times \frac{1}{3} \times 2\end{matrix} ] \times 3 + \\ \frac{1}{4}\end{matrix} ] = \frac{5}{2} ; & ( 12 ) \\ {E}_{2}^{4} = [ \begin{matrix}[ \begin{matrix}\frac{1}{4} \times \frac{1}{3} \times \frac{1}{2} \times 3 \times 2 + \\ \frac{1}{4} \times \frac{1}{3} \times 2 \times 2\end{matrix} ] \times 2 + \\ \frac{1}{4} \times 1 \times 2\end{matrix} ] = \frac{5}{3} ; & ( 13 )\end{matrix}$$

Similarly, by observing the search order of a parent point, it can be obtained with the expected value to move from the parent point to a feasible mutation point as shown in Table 1.

TABLE 1
The values of Eₘ^{N}

M

| Eₘ^{N} | | 1 | 2 | 3 | 4 | 5 | 6 |
|---|---|---|---|---|---|---|---|
| N | 3 | 2.00 | 1.33 | 1.00 | | | |
| | 4 | 2.50 | 1.67 | 1.25 | 1.00 | | |
| | 5 | 3.00 | 2.00 | 1.50 | 1.20 | 1.00 | |
| | 6 | 3.50 | 2.33 | 1.75 | 1.40 | 1.17 | 1.00 |

Where N = 3~6, and m = 1~N.

### GRPS:

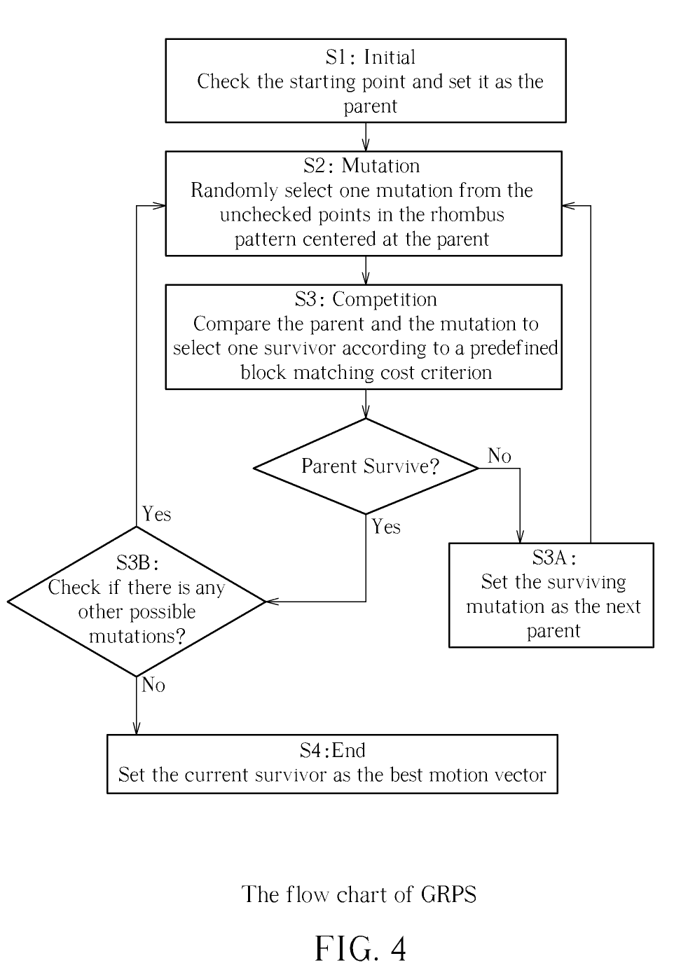

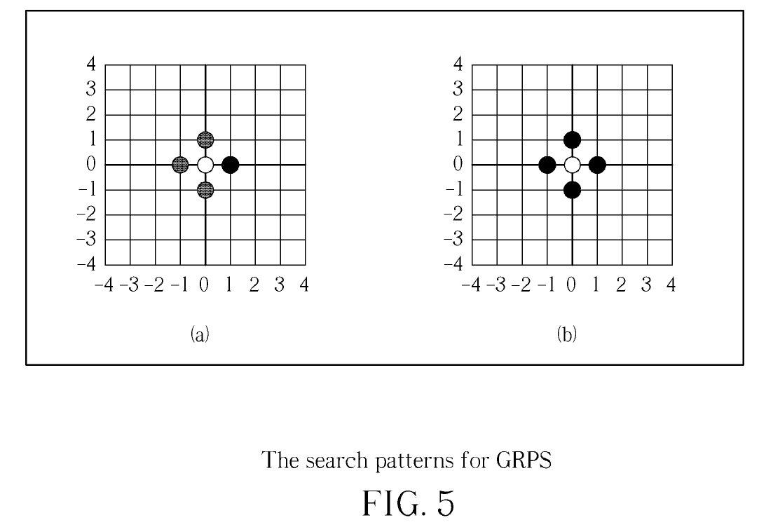

As one example, the RWF for the Genetic Rhombus Pattern Search (GRPS) is constructed. Please refer to FIG. 4 and FIG. 5 together. FIG. 4 is a flowchart of the GRPS. FIG. 5 is a diagram illustrating the search patterns of GRPS. In the search process (S2, Mutation), only one (black dot, for example) out of the four (grey and black) points in FIG. 5(a) is randomly chosen as the next check point. And the search ends when all four (black) points in FIG. 5(b) have been checked and all of them have larger matching errors than that of the center (white) point.

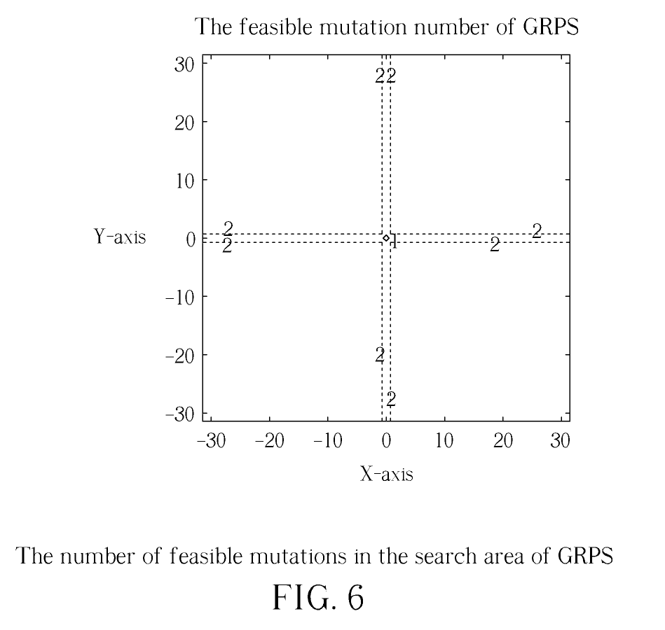

Please refer to FIG. 6. FIG. 6 is a diagram illustrating the contour plot of the feasible number of mutation points for each point in the search area. On a SQM matching error surface, it is assumed that the optimal point be the origin (0,0), and u=(x1, y1) and v=(x2, y2) be two points in the domain. The distortion at u, D(u), is smaller than D(v), if |x1|<|x2| and |y1|≦|y2|, or if |x1|≦|x2| and |y1|<|y2|.

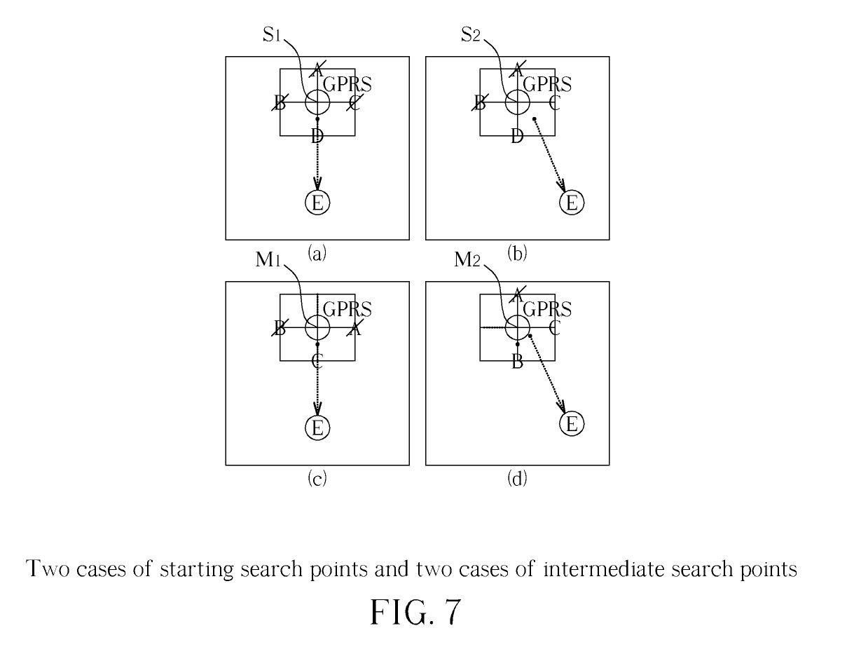

Please refer to FIG. 7. FIG. 7 is a diagram illustrating two cases of starting search points and two cases of intermediate search points. Specifically, as shown in FIG. 7, there are two types of starting search point cases (S₁^{GRPS} and S₂^{GRPS}) and two types of intermediate search point cases (M₁^{GRPS} and M₂^{GRPS}) for the GRPS. Herein, the points “A”, “B”, “C” and “D” are the search candidate points (mutation points), and the point “E” denotes the best matching point. In FIG. 7(a), only one out of the four points centered at S₁^{GRPS} may have a smaller matching error than S₁^{GRPS} when the point “E” has the same X or Y coordinate as S₁^{GRPS}. Otherwise, it is the case as shown in FIG. 7(b), which illustrates two out of the four points centered at S₂^{GRPS} may have smaller errors. Similarly, as shown in FIG. 7(c), only one out of the three points centered at M₁^{GRPS} may have smaller matching error when the point “E” has the same X or Y coordinate as M₁^{GRPS}. Otherwise, it is the case as shown in FIG. 7(d), which illustrates two out of the three points centered at M₂^{GRPS} may have smaller errors. And the expected numbers of the search points to move rom S₁^{GRPS}, S₂^{GRPS}, M₁^{GRPS} and M₂^{GRPS} to a feasible point respectively are E₁⁴(5/2), E₂⁴(5/3), E₁³(4/2) and E₂³(4/3) by looking up in Table 1.

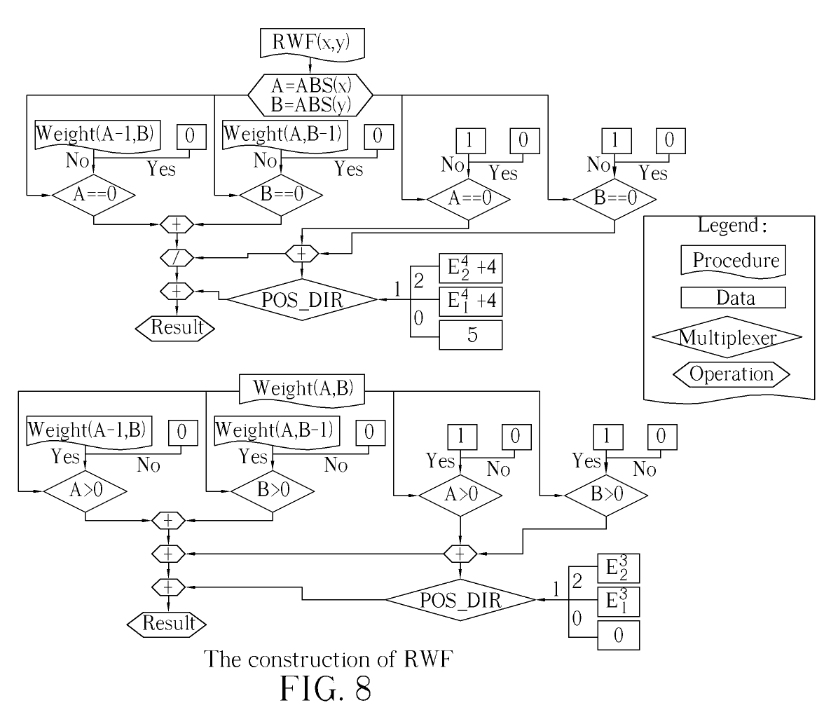

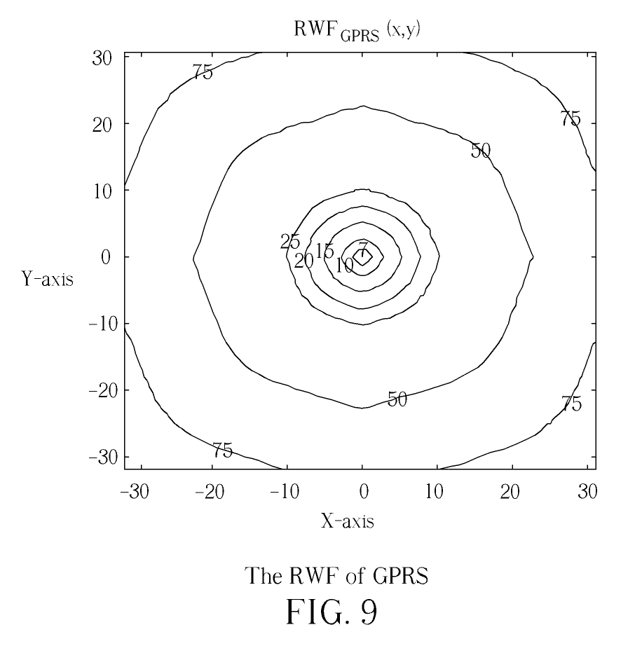

It is assumed that the coordinate of the starting point is (x,y) and the best matching point is (0,0). The number of the average search points moving from (x,y) to (0,0) is RWFGRPS(x,y). FIG. 8 shows the algorithm of calculating RWF for the GRPS according to the above analysis. FIG. 9 shows the contour plot of RWFGRPS(x,y).

### GPHS:

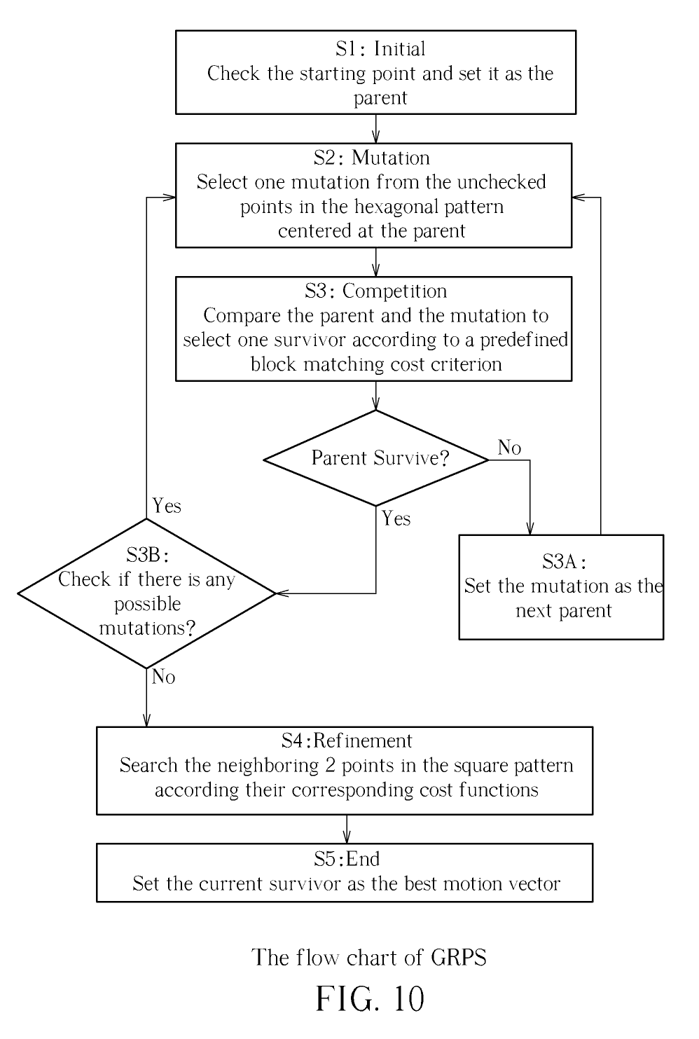

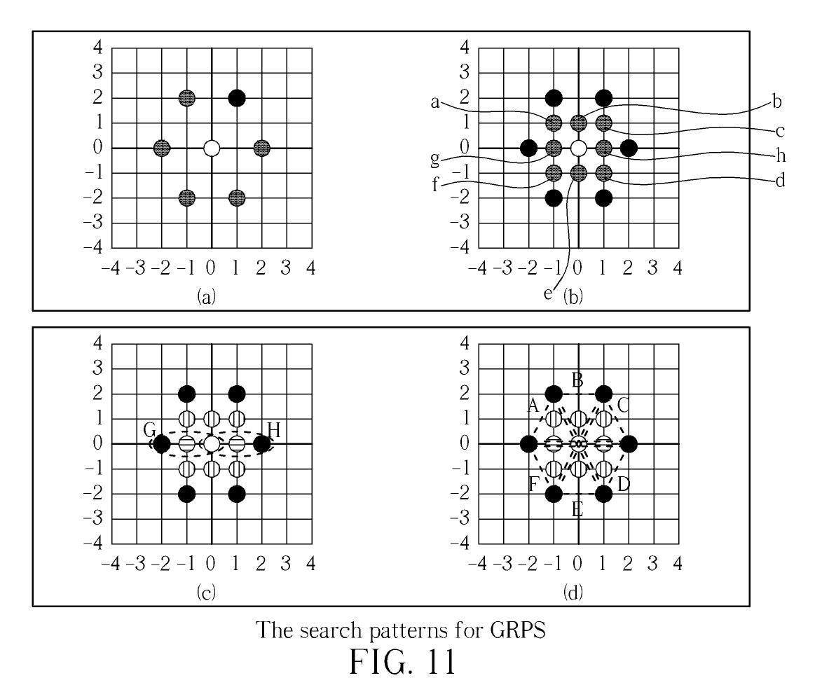

Please refer to FIG. 10 and FIG. 11 together. FIG. 10 is a flowchart of Genetic Point oriented Hexagonal Search (GPHS). FIG. 11 is a diagram illustrating the search pattern of the GPHS. In FIG. 10, Steps 2 and 3 are similar to those of GRPS but with a different large search pattern. In Step 4 (S4, Refinement), the so-called normalized group distortion (NGD) for all the grey points in FIG. 11(b) is defined by the following equation (14):

$$NGD = {\sum }_{i = 1}^{N} \frac{{SAD}_{i}}{{d}_{i}} = {\sum }_{i = 1}^{N} \frac{{SAD}_{i}}{\sqrt{{( {x}_{i} - x )}^{2} + {( {y}_{i} - y )}^{2}}} ; \qquad ( 14 )$$

where SADi denotes the SAD of neighbor i in the corresponding group, “A”˜“H”, di denotes the distance to the center, (xi, yi) and (x,y) are the coordinates of neighbor i and the center, respectively, and N is the total point number of each group in FIG. 11(c) and FIG. 11(d).

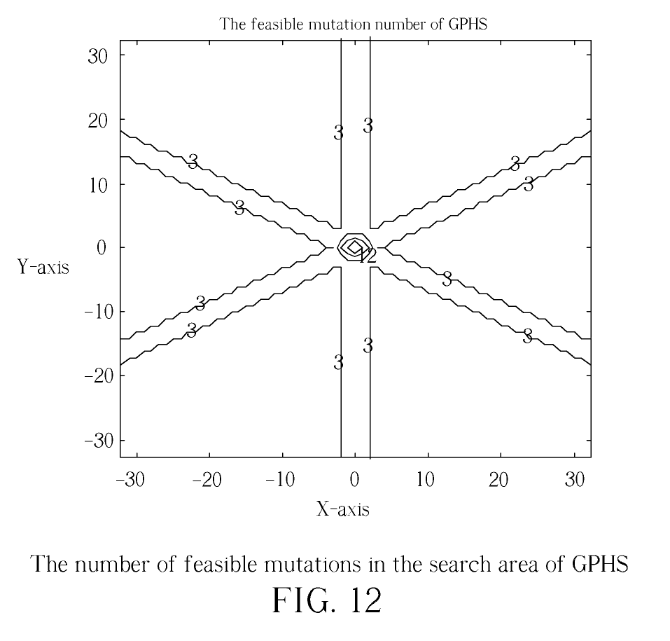

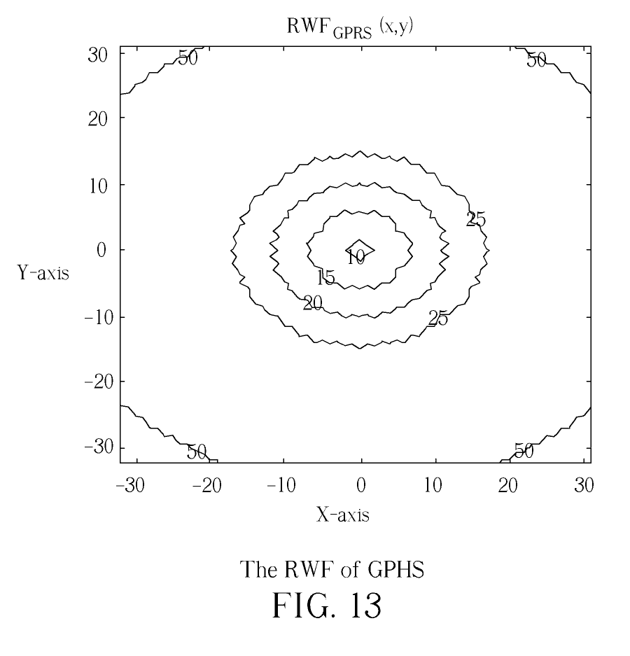

Then, the point having smallest NGD from points “a” to “f” in FIG. 11(d) is selected and one smaller NGD point from points “g” and “h” in FIG. 11(c). These two points constitute the small search pattern. Herein, the NGD of points “a” to “h” is calculated from the SADs in the groups “A” to “H”, respectively, as shown by FIG. 11(d) and FIG. 11(c). This last step is biased to the horizontal direction because most data in nature image sequences show that the horizontal movement has a higher probability. FIG. 12 shows the feasible number of mutations of GPHS. Similarly, using above information to simulate the search process of a GPHS on a SQM matching error surface, the contour plot of RWFGPHS(x,y) can be obtained in FIG. 13.

### MD-GPS:

The present invention provides two Momentum-Directed Genetic Pattern Search (MD-GPS) algorithms. The MD-GPS algorithms of the present invention are the momentum-directed version of the GRPS and the GPHS, respectively.

It is assumed that a doable search method moves at most one unit distance horizontally or vertically per step, as shown in FIG. 5(a). Then, the smallest average number of search points for reaching the point (x,y) can be expressed by the following equation:

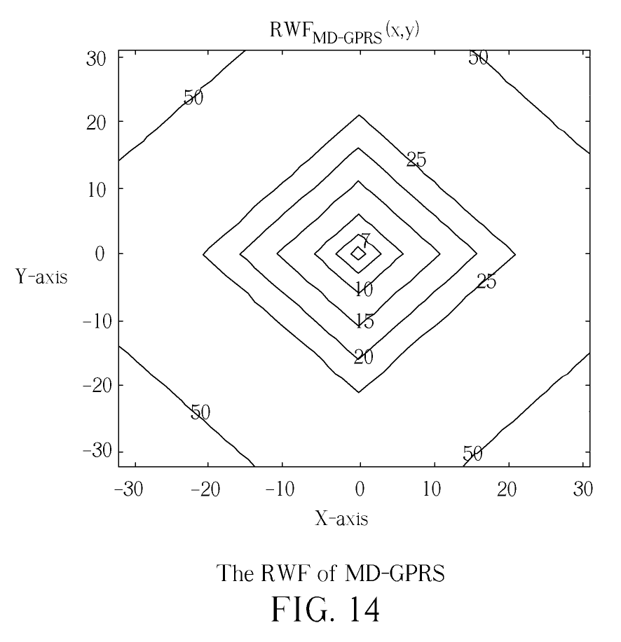

SP_{M}=abs(x)+abs(y)+1 (15);

where SP_{M} represents the smallest average number of the search points for reaching the point (x,y), abs(x) represents the horizontal distance between the point (x,y) and the starting point, and abs(y) represents the vertical distance between the point (x,y) and the starting point. At the ending stage, deciding the best motion vector generally requires examining at least the center point and its four neighboring points as shown in FIG. 5(b). Consequently, the smallest number of search points for motion vector (x,y) can be expressed by the equation (16) and its contour plot is shown by FIG. 14. The equation (16) is expressed as follows:

RWF_{GRPS}(x,y)=Max(5,4+abs(x)+abs(y)) (16).

Comparing FIG. 14 to FIG. 9, it is obvious that the RWF of GRPS does not match the ideal RWF. However, by observing the ideal RWF carefully, it can be understood that the algorithm should proceed straightly towards the best matching point. Statistically, the successful direction of the previous search likely reappears at the current point. Therefore, instead of randomly select one mutation point from the candidate child point set, the mutation point is selected according to its likelihood to be a successful mutation. That is, it tends to move along the same direction of the prior successful search. On the other hand, it can still change the search directions when the assumption of monotonic matching error surface is not totally valid.

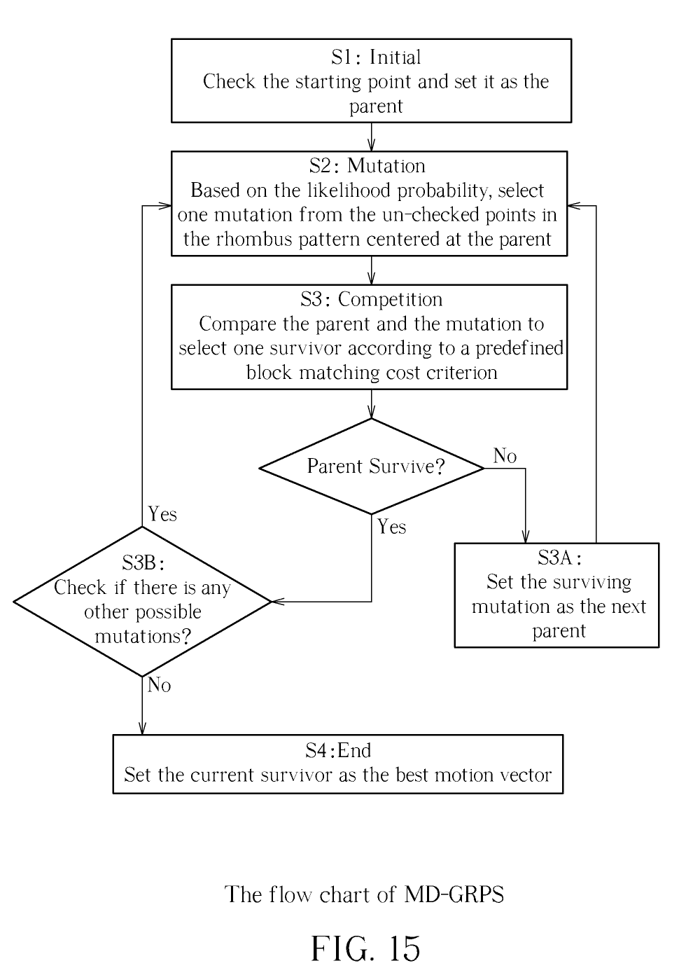

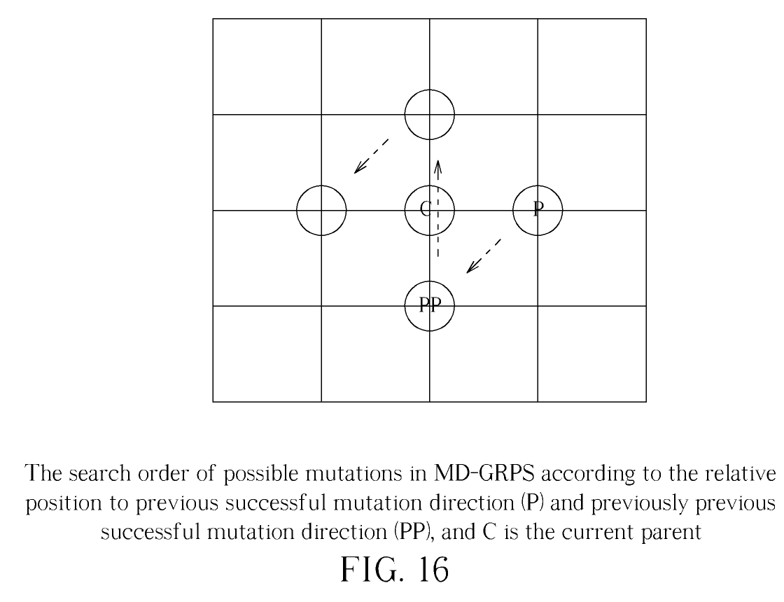

Please refer to FIG. 15. FIG. 15 is a flowchart illustrating the MD-GRPS algorithm of the present invention. Please refer to FIG. 16. FIG. 16 is a diagram illustrating the search order of possible mutation points of MD-GRPS algorithm of the present invention. As shown in FIG. 16, “P” represents the previous successful mutation direction, and “C” represents the current parent point. “PP” represents the previously previous successful mutation direction. The search order of possible mutation points in MD-GRPS is:
(1)^{st} the mutation point with the same direction as the previous successful mutation point;
(2)^{nd} the mutation point with the same direction as the previously previous successful mutation point;
(3)^{rd} the mutation point with the opposite direction as the previously previous successful mutation point; and
(4)^{th} the mutation point with the opposite direction as the previous successful mutation point.

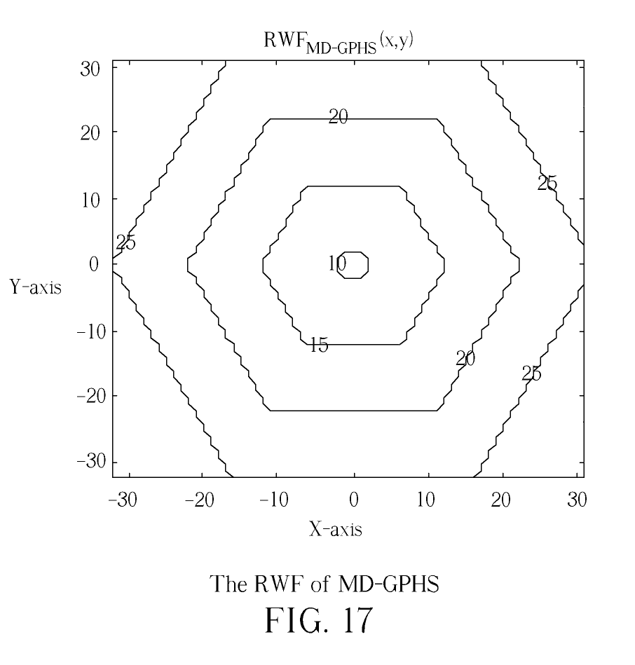

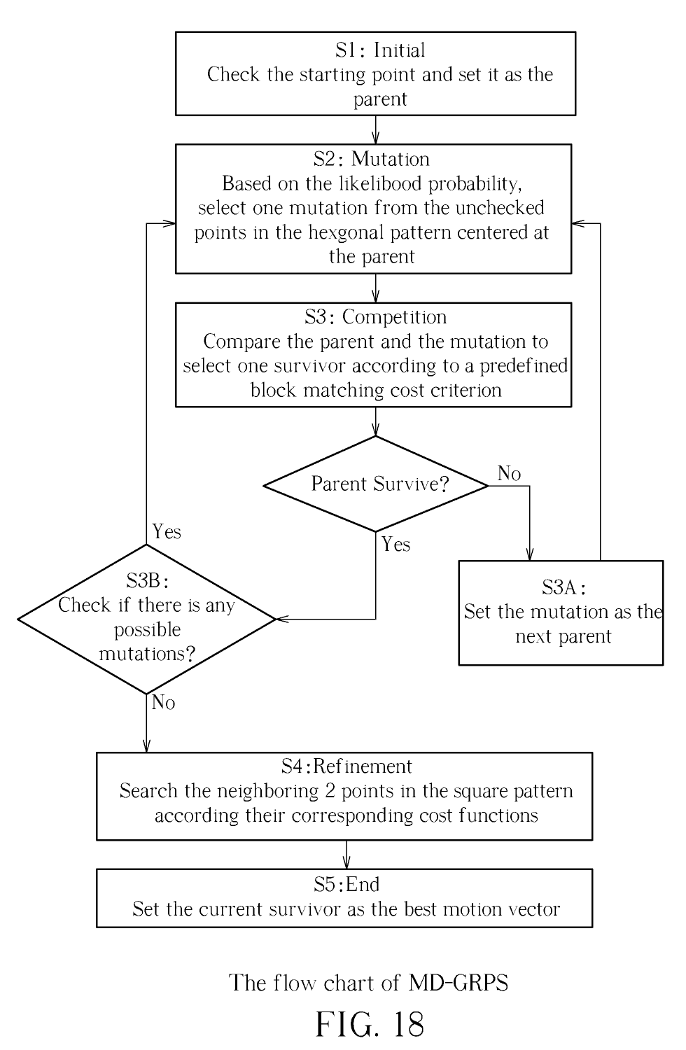

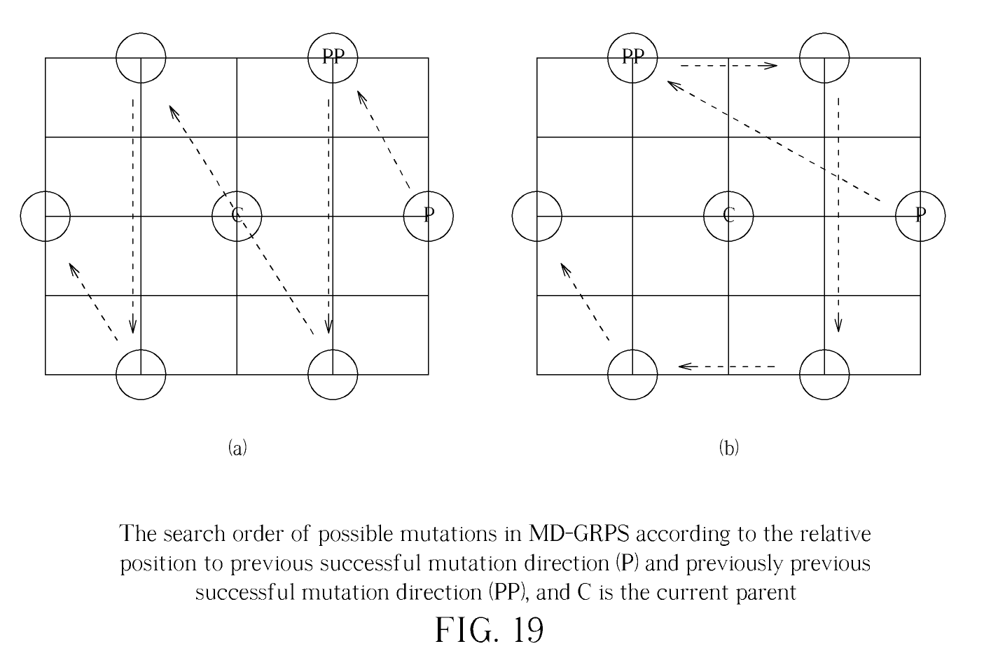

Likewise, by adopting the momentum-directed search order in the genetic pattern search, the GPHS algorithm can be converted into a momentum-directed one. FIG. 17 shows the contour plot of RWF of the momentum-directed GPHS algorithm of the present invention. Please refer to FIG. 18. FIG. 18 is a flowchart of the momentum-directed GPHS (MD-GPHS) algorithm of the present invention. The search order of possible mutation points in MD-GPHS algorithm is shown in FIG. 19.

Additionally, the motion vector variance mentioned in the present invention is only illustrated for better understanding. However, any other motion vector related index can be utilized instead, e.g. motion vector standard deviations, or other mathematically equivalent or approximate index.

To sum up, the present invention provides a mathematical model of pattern search algorithms, and more particularly, a refined mathematical model for genetic pattern search algorithms. In the refined model of the present invention, refined weighting function (RWF) is defined as the average number of search points required by a search algorithm on a SQM matching error surface and is proposed as a better replacement for the weighting function (WF). When the behavior of a genetic pattern search algorithm is described more precisely, it is understood better on how a genetic pattern search works. Based on such insights, a general way to further improve the performance of genetic pattern searches is given by the present invention. Two momentum-directed genetic pattern search algorithms are devised as well. Moreover, when the RWF is adopted in the model to predict the performance of a new genetic search algorithm, the prediction accuracy is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive method of performing block motion estimation comprising:
(a) calculating a motion vector related index for a first frame according to a first search pattern;
(b) determining a relationship between the motion vector related index and a predetermined threshold for the first frame; and
(c) selecting a first or a second search pattern algorithms for identifying one or more search blocks in a second frame according to the determined relationship between the motion vector related index and the predetermined threshold for the first frame;
wherein the predetermined threshold is determined by refined weighting functions of the first and the second search pattern algorithms;
wherein the refined weighting functions of the first and the second pattern algorithms are numbers of average search points for the first and the second pattern algorithms searching in the first frame;
wherein block motion estimation is performed adaptively for the second frame.

2. The method of claim 1, wherein the motion vector related index is the motion vector variance, motion vector standard deviations, or other mathematically equivalent or approximate index.

3. The method of claim 1, wherein each of the first and the second search pattern algorithms comprise momentum-directed genetic pattern algorithms.

4. The method of claim 3, wherein the step (c) further comprising:
selecting the first search pattern algorithm for identifying at least one search block in the second frame when the motion vector related index exceeds the predetermined threshold.

5. The method of claim 4, wherein the momentum-directed genetic algorithm of the first search pattern comprises a hexagonal shaped algorithm.

6. The method of claim 3, wherein step (c) further comprising:
selecting the second search pattern algorithm for identifying at least one search block in the second frame when the motion vector related index is equal or less than the predetermined threshold.

7. The method of claim 6, wherein the momentum-directed genetic algorithm of the second search pattern comprises a rhombus shaped algorithm.

8. The method of claim 1, wherein the motion vector related index is determined by analyzing a reference frame.

9. A momentum-directed genetic pattern search method of performing block motion estimation for a frame, the method comprising:
(a) selecting a child point proximate to a parent point according to likelihood of the parent point according to previous successful mutations;
(b) comparing block matching cost of the parent point and block matching cost of the child point; and
(c) setting either the parent point or the child point as a surviving parent point for a successful mutation according to the compared result of the step (b).

10. The method of claim 9, further comprising:
(d) repeating the steps (a) to (c) until all child points proximate to the surviving parent point have been checked and the surviving parent point is still set as the surviving parent point according to the compared result of the step (b) and setting the surviving parent point as a final surviving parent point; and
(e) identifying a motion vector for the frame according to the final surviving parent point.

11. The method of claim 9, further comprising:
(f) identifying a starting point within the frame as the parent point.

12. The method of claim 9, wherein the child point is immediately adjacent to the parent point.

13. The method of claim 9, wherein comparing block matching cost of the parent point and block matching cost of the child point comprises:
comparing a sum of absolute differences of the parent point between a sum of absolute differences of the child point.

14. The method of claim 9, wherein said child point is selected from at most four candidate points.

15. The method of claim 10, further comprising:
(j) determining a direction according to the parent point and the surviving parent point.

16. The method of claim 15, wherein the child points checked in the step (d) are selected according to likelihood of the direction determined in the step (j).

17. A momentum-directed genetic rhombus pattern search method of performing block motion estimation for a frame, the method comprising:
(a) selecting a child point from a perimeter portion of a rhombus centered about a parent point according to likelihood of the parent point according to previous successful mutations;
(b) comparing block matching cost of the parent point and block matching cost of the child point; and
(c) setting either the parent point or the child point as a surviving parent point for a successful mutation according to the compared result of the step (b).

18. The method of claim 17, further comprising:
(d) repeating the steps (a) to (c) until all child points from the perimeter portion of the rhombus centered about the surviving parent point have been checked and the surviving parent point is still set as the surviving parent point according to the compared result of the step (b) and setting the surviving parent point as a final surviving parent point;
wherein the child points are also determined by reference to a rhombus pattern centered about the surviving parent point; and
(e) identifying a motion vector for the frame according to the final surviving parent point.

19. The method of claim 17, further comprising:
(f) identifying a starting point within the frame as the parent point by performing a block matching operation within the frame.

20. The method of claim 17, wherein in the step (c), the child point is selected as the surviving point when the block matching cost of the child point is lower than the block matching cost of the parent point without computing block matching costs of other remaining unchecked child points.

21. A momentum-directed genetic hexagonal pattern search method of performing block motion estimation for a frame, the method comprising:
(a) selecting a child point from a perimeter portion of a hexagon centered about a parent point according to likelihood of the parent point according to previous successful mutations;
(b) comparing block matching cost of the parent point and block matching cost of the child point; and
(c) setting either the parent point or the child point as a surviving parent point for a successful mutation according to the compared result of the step (b).

22. The method of claim 21, further comprising:
(d) repeating the steps (a) to (c) until all child points from the perimeter portion of the hexagon centered about the surviving parent point have been checked and the surviving parent point is still set as the surviving parent point according to the compared result of the step (b) and setting the surviving parent point as a final surviving parent point;
wherein the child points are also determined by reference to a hexagonal pattern centered about the surviving parent point; and
(e) identifying a motion vector for the frame according to the final surviving parent point.

23. The method of claim 21, further comprising:
(f) identifying a starting point within the frame as the parent point by performing a block matching operation within the frame.

24. The method of claim 21, wherein in the step (c), the child point is selected as the surviving point when the block matching cost of the child point is lower than the block matching cost of the parent point without computing block matching costs of other remaining unchecked child points.

25. The method of claim 21, further comprising:
(h) performing a fine searching operation on selected points situated between the parent point and the child points situated on the hexagon perimeter portion.

26. The method of claim 25, further comprising:
(i) ranking the child points according to each weighted sum of block distortions of child points neighboring a corresponding child point; and
(j) selecting a point of the ranked child points having minimal sum of the block distortions of the child points neighboring the point among the child points.

27. The method of claim 25, wherein a number of selected points which are checked in the step (h) is determined by a direction of the motion vector.
